(19) United States
(12) Patent Application Publication
(10) Pub. No.: US 2008/0185165 A1
(43) Pub. Date: Aug. 7, 2008

(54) Hand-held power tool with an oscillation damper

(76) Inventor: Franz Moessnang, Landsberg (DE)

Correspondence Address: ABELMAN, FRAYNE & SCHWAB, 666 THIRD AVENUE, 10TH FLOOR, NEW YORK, NY, 10017, US

(21) Appl. No.: 12/011,894

(22) Filed: Jan. 29, 2008

(30) Foreign Application Priority Data
Jan. 31, 2007 (DE) 10 2007 000 059.8

(51) Int. Cl. B25D 17/24

(52) U.S. Cl. 173/211; 173/162.1

(57) ABSTRACT

A hand-held power tool includes a pneumatic percussing mechanism (3) located in the power tool housing (2) and having an anvil (5) and a percussion piston (4) for applying blows to the anvil (5), and at least one oscillation damper (6, 6′) including an oscillation damping mass (7, 7′), at least one spring (8a, 8a′) for compressively preloading the damping mass (7, 7′) against the power tool housing (2), and an axially displaceable excitation member (9) for actively exciting the oscillation damper (6, 6′) in response to the anvil (5) occupying an operational position.

### BACKGROUND OF THE INVENTION

1. Field of the Invention

The present invention relates to a hand-held power tool and, in particular, a hammer drill, a combination hammer and chisel hammer with an active oscillation damper.

2. Description of the Prior Art

An oscillation damper represents an oscillation-capable sub-system that consists of an abstract oscillating mass, an abstract spring, and an abstract damper and that is not necessarily needed to be explicitly formed of concrete components. In particular, the abstract damper often is not formed by concrete components but nevertheless functions by using friction and flow losses which practically always present. There exist two types of dampers, conventional passive oscillation dampers that exclusively are self-excited, and actively controlled dampers which are purposefully independently excited, using primarily a periodic excitation function.

By a suitable selection of spring constant and mass, in a passive damper, its natural frequency can be so dimensioned that it is closed to a to-be-damped interference frequency, in the present case, to the oscillations of the outer housing of the hand-held power tool.

With an active oscillation damper, which is excited primarily with a frequency above the natural frequency by the interference frequency, a good reduction of vibrations of the outer housing is achieved without a damaging beat effect.

French Publication FR 2,237,734 discloses use of a passive oscillation damper for preventing oscillation of a housing of a percussion hand-held power tool.

U.S. Pat. No. 4,478,293 discloses synchronization of operation of two passive oscillation dampers by using compressed air pulsation.

German Publication DE 815 179 discloses an arrangement of two passive oscillation dampers on opposite lateral sides of a percussion mechanism.

European Publication EP 1 710 052 discloses an arrangement of a hollow cylindrical passive oscillation damper around of a guide tube of a percussion mechanism.

International Publication WO 2006/022345 discloses an arrangement of a plurality of compact oscillation dampers within the outer housing of a power tool.

European Publication EP 1 464 449 discloses an arrangement of an actively controlled oscillation damper about a guide tube of a percussion mechanism and which is controlled by pressure fluctuations produced during driving of a drive piston of the power tool. At a faulty pressure of the power tool against an object, in addition to deactivation of the percussion mechanism, the oscillation damper, which is actively controlled by a displaceable control sleeve, is also deactivated.

An object of the present invention is to provide a hand-held power tool having a constructively simple oscillation damper that becomes deactivated at a faulty pressure of the power tool against an object.

### SUMMARY OF THE INVENTION

This and other objects of the present invention, which will become apparent hereinafter, are achieved by providing a hand-held power tool including a housing, a pneumatic percussion mechanism located in the housing and having an anvil and a percussion piston for applying blows to the anvil, and at least one oscillation damper including an oscillating damping mass, at least one spring for compressively preloading the damping mass against the power tool housing, and an axially displaceable excitation member for actively exciting the oscillation damper in response to the anvil occupying an operational position.

With the excitation of an oscillation damper by an anvil, the oscillation damper will be only then activated with a frequency of blows when the anvil occupies, as a result of the power tool being pressed against an object, its operational, action-ready, position, and would not be activated as a result of a faulty press-on of the power tool in an idle blow position in which the oscillation damper passively oscillates.

Advantageously, the excitation member at least partially circumferentially engages a guide tube for the anvil. Thereby, the excitation member becomes displaced by a direct contact with the anvil, in particular during a rebound of a percussively driven working tool.

Advantageously, the excitation member is formed as a ring-shaped member. Therefore, when the excitation member is in contact with the anvil, no inclination or bending takes place.

Advantageously, the oscillation damper is formed as a hollow cylindrical element, which permits to circumferentially arrange it about the pneumatic percussion mechanism.

Alternatively, the oscillation damper can be formed as a compact element, which permits to arrange it sidewise of the pneumatic percussion mechanism as it occupies little space.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a cross-sectional longitudinal partial view of a hand-held power tool according to the present invention with an oscillation damper; and

FIG. 2 a view similar to that of FIG. 1 of another embodiment of a hand-held power tool according to the present invention with an oscillation damper.

### DETAILED DESCRIPTION OF THE PREFERRED EMBODIMENTS

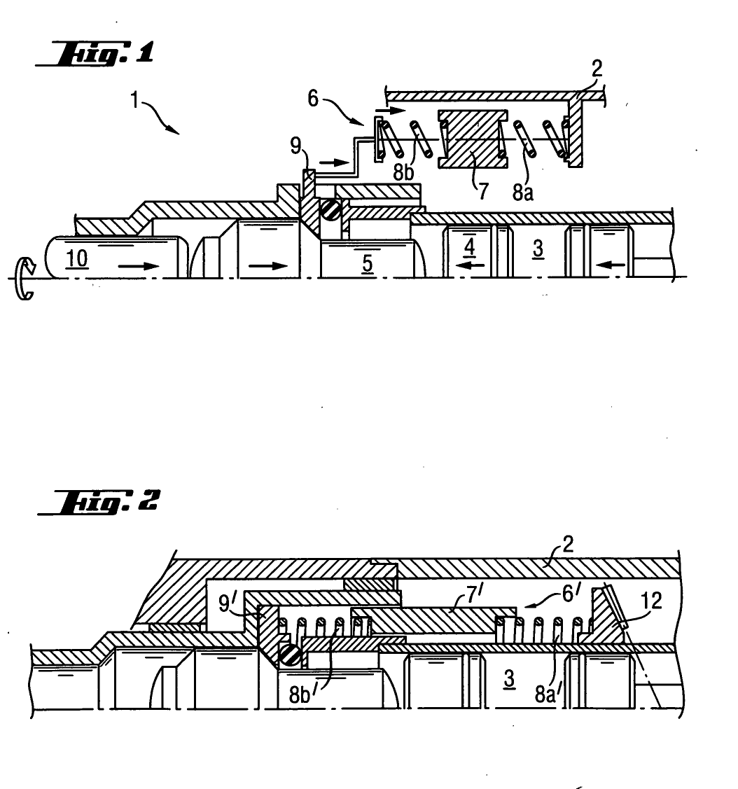

A hand-held rotary-percussion power tool 1, which is shown in FIG. 1 includes a housing 2, a pneumatic percussion mechanism 3 located in the housing 2 and having an anvil 5 and a percussion piston 4 for applying blows to the anvil 5, and two compact oscillation dampers 6 of which only one oscillation damper is shown in the drawing. The dampers 6 are arranged mirror-symmetrically. The oscillation damper 6 has an oscillating damping mass 7 that is axially compressively preloaded against the housing 2 by a first spring 8a. In addition, a second spring 8b connects the damping mass 7 with an axially displaceable excitation member 9 that actively excites the oscillation damper 6 in response to the anvil 5 being pushed back by a rebounding working tool 10. The excitation member 9 partially circumferentially engages the guide tube 11 in which the anvil 5 is displaceable.

In the embodiment shown in FIG. 2, the oscillation damper 6′ is formed as a hollow cylindrical element (with respect to the damping mass 7′ and first and second springs 8a′ and 8b′) that surrounds the pneumatic percussion mechanism 3. The excitation member 9′ is formed as a ring-shaped member. Also, in the embodiment shown in FIG. 2, the first spring 8a′ supports the oscillation damper 6′ axially against a drive pinion 12 that is fixedly secured axially in the housing 2.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A hand-held power tool, comprising a housing (2); a pneumatic percussion mechanism (3) located in the housing (2) and including an anvil (5) and a percussion piston (4) for applying blows to the anvil (5); and at least one oscillation damper (6, 6′) including an oscillation damping mass (7, 7′), at least one spring (8a, 8a′) for compressively preloading the damping mass (7, 7′) against the power tool housing (2), and an axially displaceable excitation member (9) for actively exciting the oscillation damper (6, 6′) in response to the anvil (5) occupying an operational position thereof.

2. A hand-held power tool according to claim 1, wherein the excitation member (9) at least partially circumferentially engages a guide tube (11) for the anvil (5).

3. A hand-held power tool according to claim 1, wherein the excitation member (9) is formed as a ring-shaped member.

4. A hand-held power tool according to claim 1, wherein the oscillation damper (6′) is formed as a hollow cylindrical element.

5. A hand-held power tool according to claim 1, wherein the at least one oscillation damper (6, 6′) is arranged sideways of the pneumatic percussion mechanism (3).
